(19) United States
(12) Patent Application Publication
(10) Pub. No.: US 2023/0170558 A1
(43) Pub. Date: Jun. 1, 2023

(54) Protective Device for Battery Cells

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Martin HILLER, Karlsfeld (DE); Christophe MILLE, Villard de Lans (DE); Frederik MORGENSTERN, San Francisco, CA (US); Nikolaos TSIOUVARAS, Athen (GR); Seokyoon YOO, Baldham (DE)

(21) Appl. No.: 17/922,901

(22) PCT Filed: Jun. 9, 2021
(86) PCT No.: PCT/EP2021/065414

§ 371 Date: Nov. 2, 2022

(30) Foreign Application Priority Data
Jul. 8, 2020 (DE) 10 2020 117 976.6

(51) Int. Cl. H01M 50/143; H01M 50/289

(52) U.S. Cl. CPC H01M 50/143; H01M 50/289; H01M 2220/20

(57) ABSTRACT

A protective device for battery cells, a plurality of which are assembled to form a module for an electric drive of a vehicle, has a frame made of plastic provided between the battery cells and coated with a fire-retardant coating. The frame laterally separates each battery cell from the other battery cells. A further fire-retardant coating is preferably additionally applied directly onto a housing of the battery cells. An air gap can be provided between each battery cell and each separation chamber of the frame.

### BACKGROUND AND SUMMARY

The present invention relates to a protective device for battery cells, particularly in an electrically driven motor vehicle, a plurality of which are combined in high-voltage storage modules and which may be exposed to thermal loads. It concerns in particular battery modules with lithium ion cells.

In order to provide electrical drive energy for motor vehicles, storage batteries, also referred to for example as high-voltage batteries, high-voltage storage units and traction batteries, are known. In order to supply electrical drives of vehicles, electrical energy with a relatively high voltage of, for example, from 400 V to 800 V is required. High-voltage storage units are in general currently constructed not in monobloc fashion but modularly from a plurality of battery cells. This increases the design freedom and allows the use of relatively economical standard cells which can be produced as mass products, instead of individual specially manufactured ones. The number of battery cells used is also directly related to the range of electrical or hybrid vehicles. In practice, round cells, prismatic battery cells, in particular flat cells, or so-called pouch cells are used as battery cells for high-voltage storage units.

The amount of heat generated during operation of the high-voltage storage unit is relatively large and, because of the packing density and the often encapsulated or at least narrow installation, without high-performance cooling the resulting temperatures would greatly exceed acceptable parameters. In this case, innovative cooling concepts are an important factor in preventing overheating of the battery systems and the associated consequences, such as reduction of the range and shortened lifetime of the battery modules.

Furthermore, in the event of a battery cell defect, a first battery cell may run away thermally and bunt because of a large temperature rise. Hot gases and soot particles in this case emerge. The emerging gases and particles are distributed over the module and may heat neighboring cells. If a temperature rise due to this heat transfer exceeds a critical threshold, further cells may also run away thermally (thermal propagation).

It is therefore an object of the present invention to prevent propagation in the event of thermal runaway of a battery cell as much as possible.

The object is achieved by the features of the independent claims. The dependent claims relate to advantageous refinements and advantageous embodiments.

The invention relates in particular to a protective device for battery cells, a plurality of which are combined to form a module for an electrical drive of a vehicle, wherein a plastic frame, which is enveloped with a fire-suppressing layer and laterally separates each battery cell from the other battery cells, is provided between the battery cells. Preferably, a fire-suppressing layer is additionally applied directly onto the housing of the battery cells.

An air gap may be provided between each battery cell and each separation chamber of the frame.

The invention is based on the following considerations.

Ensuring safety of the battery is one of the main challenges in electromobility. In the event of thermal runaway of a cell, during which temperatures of up to 1200° C. may be reached, neighboring cells are put at risk of overheating and likewise experiencing thermal runaway. This effect is also referred to as thermal propagation. For improved passenger safety, it is important to prevent or at least retard thermal propagation as much as possible.

There are various possibilities for preventing thermal propagation, for example:
cells with a reduced energy density may be installed;
a thermally insulating mat or aerogel (porous solid foam material) may be installed between the cells (particularly in the case of prismatic cells);
a thermally insulating encasing compound or foam may be placed between the cells;
an air gap may be maintained between the cells.

Thermal propagation may occur if the neighboring cells are heated by thermal conduction and thermal radiation to above about 150° C.

A further trigger event, which is much more difficult to manage, is side rupture of the cell. In this case, a large amount of heat energy may be transferred in a short time to the neighboring cells. Particularly when the cells are insulated by air, propagation by side rupture can be controlled only with difficulty. Thermal insulating mats are often expensive, and they are furthermore not easy to install, particularly in modules with small round cells, since in this case they need to be inserted around a large number of cells. Thermal foams often contain silicone, which is not readily used in the automobile sector because of volatile constituents and their effects on paint, etc. Furthermore, silicone-containing foams or encasing compounds are likewise expensive and rather heavy.

The basic idea of the invention is to use a plastic frame, which is enveloped with a fire-suppressing layer, between the cells. As an alternative or in addition, this layer may also be applied directly onto the cells. Advantages of this are the use of a very lightweight and economical material (plastic), which is installed in the module as a separating element between the cells in the form of a frame. This plastic is thus coated with a thermal insulation layer. This layer may for example:
consist of a material which is converted into ceramic by heating (for example ceramizing elastomers);
consist of a material which forms a thermally insulating foam by heating;
consist of materials which undergo an endothermic chemical or physical process, which absorbs heat, at elevated temperatures; or
be a combination of the aforementioned materials.

Possible coating manufacturers may be:
Unifrax FyreWrap® LiB Films & Coatings
Audax Renitherm®
etc.

Particularly in the event of side rupture, such a frame can suppress thermal propagation substantially better than, for example, an air gap between the cells. Since these incidents are usually very short, materials such as plastic, which would melt at these temperatures, may also be used because of the extra protection of the thermal envelope.

The invention will be explained with the aid of exemplary embodiments.

### BRIEF DESCRIPTION OF THE DRAWINGS

FIG. 1 is a schematic view of a plurality of battery cells in a frame according to an embodiment of the invention; and

FIG. 2 is a schematic view of a separation chamber of the frame for a battery cell with different layer-envelope alternatives.

### DETAILED DESCRIPTION OF THE DRAWINGS

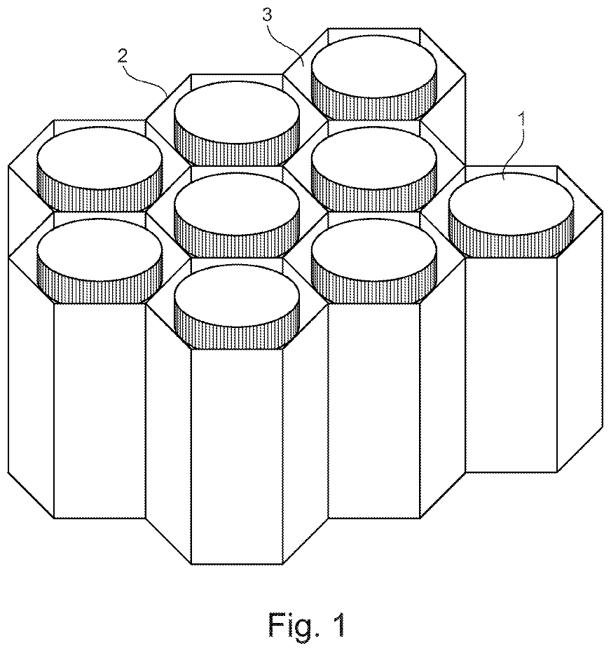

FIG. 1 shows a protective device for battery cells 1, a plurality of which are combined to form a module for an electrical drive of a vehicle. The protective device comprises in particular a plastic frame 2 between the battery cells 1, an air gap 3 preferably being provided between each battery cell 1 and each separation chamber of the frame 2. The frame 2 creates separation chambers, which laterally separate each battery cell 1 from the other battery cells 1.

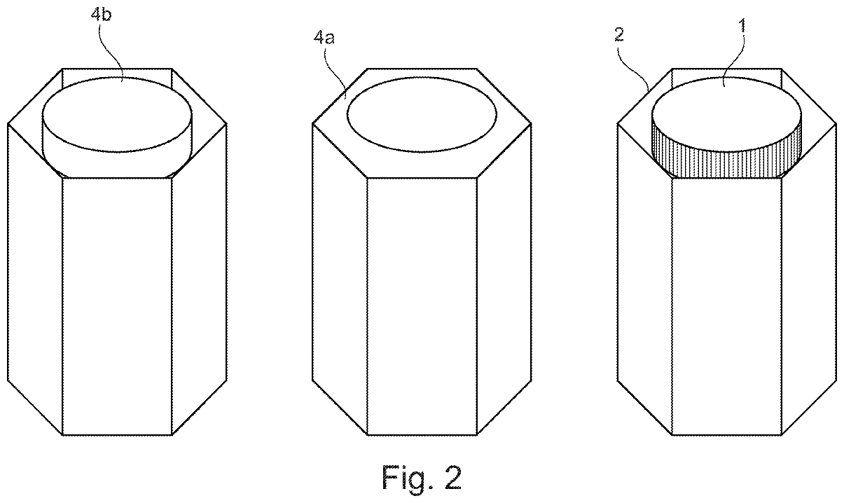

FIG. 2 shows in the middle (black) that the frame 2 is enveloped with a fire-suppressing layer 4a. On the left side of FIG. 2, it is shown (black) that, as an alternative or in addition, the housing of the battery cells 1 may be enveloped with a fire-suppressing layer 4b. The two layers 4a and 4b may be different, and in particular the layer 4b may be thinner or lighter than the layer 4a; this is because the frame 2 is preferably formed by a plastic that is as lightweight and/or thin as possible.

1-4. (canceled)

5. A protective device, comprising:
a plurality of battery cells that are combined to form a module for an electrical drive of a vehicle; and
a plastic frame, which plastic frame is enveloped with a first fire-suppressing layer and comprises separation chambers that laterally separate each of the plurality of battery cells from one another, wherein
the plastic frame is provided between the battery cells.

6. The protective device as claimed in claim 5, further comprising:
a second fire-suppressing layer additionally applied directly onto housings of the battery cells.

7. The protective device as claimed in claim 5, wherein
an air gap is provided between each battery cell and each separation chamber of the frame.

8. A vehicle comprising a protective device as claimed in claim 5.
